(19) United States
(12) Patent Application Publication
(10) Pub. No.: US 2003/0014688 A1
(43) Pub. Date: Jan. 16, 2003

(54) Nonvolatile memory unit comprising a control circuit and a plurality of partially defective flash memory devices

(76) Inventor: Chwan-Chia Wu, Taipei (TW)

Correspondence Address: William E. Pelton, COOPER & DUNHAM LLP, 1185 Avenue of Americas, New York, NY, 10036, US

(21) Appl. No.: 10/082,013

(22) Filed: Feb. 21, 2002

Related U.S. Application Data
(63) Continuation of application No. 09/902,200, filed on Jul. 10, 2001.

(51) Int. Cl. G06F 11/00

(52) U.S. Cl. 714/7

(57) ABSTRACT

A nonvolatile memory unit includes a control circuit and a plurality of partially defective flash memory devices of the same kind. Each flash memory device is partly defective. The defective cells are in predefined regions. The defective areas of each device are complementary to non-defective areas of other devices. This ensures that each defective area of a device can be replaced by a non-defective area of another device, both mapping to the same region of memory. A switching mechanism facilitates writing to the flash memory devices simultaneously, examines read commands issued by the external circuit, and determines the associated data read cycle to read data from all of the attached flash memory devices simultaneously but selectively connects the data lines to ensure that data are read from non-defective areas. The unit can therefore be used as a non-defective despite its defects.

### BACKGROUND OF THE INVENTION

1. Field of Invention

The present invention relates to a nonvolatile memory unit comprising a control circuit and a plurality of partially defective flash memory devices. In particular, the invention relates to a control circuit that facilitates writing of data into a plurality of partially defective flash memory devices simultaneously when write operations are performed, and more particularly, relates to reading out data in accordance with the desired addresses from non-defective storage cells in these flash memory devices when read operations are performed.

2. Related Art

A flash memory is a nonvolatile memory in which data can be erased or written electrically. Due to the ability of programming data directly on the circuit board, the flash memory is widely used as a storage component for storing program code of an apparatus having CPU or for storing data as a secondary storage unit of a digital system. The nature of relatively low cost, large capacity, low power consumption, resistance of vibration and small size makes the flash memory a superb storage media for a wide variety of mobile or portable apparatus.

The flash memory receives control data such as chip select, command latch, etc. to activate decoding and execution of given instructions from the external circuit. The flash memory also receives control data such as read/write commands, address data, etc. from the external circuit to perform the desired memory access operations.

As the capacity of flash memory device is increased, the density and integration of memory cells is also increased. In such a flash memory device, the failure of even a few memory cells leads to the failure of the flash memory device as a whole, thereby resulting in crucially lowered manufacturing yield. In order to improve the yield of flash memory devices, redundant circuit, called on-chip redundant circuit, has been provided in each device so that defective memory cells are replaced by redundant memory cells. However, the effect of replacement by on-chip redundant circuit tends to fall as integration and capacity of the flash memories are made higher and larger. Specifically, when one prior flash memory device has more defective cells than the redundant memory cells or the defective cells can not be replaced by the redundant memory cells, this particular prior flash memory device then cannot be used and has to be rejected. Typically, the memory cells other than the defective memory cells of a flash memory device can still be accessed for data storage. It is thereby a waste to discard the entire flash memory device because of a few defective memory cells within the memory array.

Therefore, prior art such as the memory card set forth in U.S. Pat. No. 5,524,231 provides a reprogrammable nonvolatile memory card that can map out the defective portions in each of the memories of the memory card. Prior art disclosed in U.S. Pat. No. 5,883,842, also provides a memory card which is adapted to use partly defective block erasure type nonvolatile memory devices when a plurality of such memory devices are connected in parallel to each other to achieve longer bit length for data storage. Other prior arts are disclosed to furnish similar objective to use partially defective nonvolatile memory devices for different application purposes. All of the prior arts thus far mainly treat sectors or blocks as basic units of defects, and to perform sector or block level replacement for the defective portions. However, like the fault patterns commonly found in random access memory (RAM) chips, the defective cells may fall in a certain bit locations, and accordingly taking sectors or blocks as the basic unit for replacement of defective cells may result in a discard of the entire flash memory chip. In this case, replacement of defective bits rather than defective sectors or blocks is desired to achieve more effective use of the defective flash memory. Current industry practices for resolving the bits replacement of RAM chips are to utilize additional RAM chips, partially defective or totally non-defective, to replace the defective bits by isolating the defective bits from the system data bus. Nevertheless, unlike random access memory in which the read/write commands are entered via control lines separated from data bus, the flash memory uses data bus to enter commands for performing desired operations. Therefore, isolation of a certain bit lines of a flash memory device from system data bus may result in a totally non-operative state of that particular flash memory device as complete commands cannot be entered properly.

### SUMMARY OF THE INVENTION

One of the objects of the present invention to provide a preprogrammable nonvolatile memory unit comprising a control circuit and a plurality of flash memory devices of the same kind and having partially defective portions in each device.

Another object of the present invention is to provide a preprogrammable nonvolatile memory unit that can map out the defective portions with a prescribed defective pattern in each of the flash memory devices of the memory unit.

Another object of the present invention is to facilitate effective use of the partially defective flash memory devices in which the defective memory cells can be replaced based on address level or bit level.

Another object of the present invention is to treat this preprogrammable nonvolatile memory unit as a non-defective flash memory device having exactly the same specifications of the flash memory devices constituting the prescribed memory unit, disregarding where the defects are located.

Another object of the present invention is to provide a control circuit that can be adapted to different kinds of flash memory devices so as to form a preprogrammable nonvolatile memory unit.

A further object of the present invention is to use the partially defective flash memory devices and to provide a reprogrammable nonvolatile memory unit that is cost effective.

A nonvolatile memory unit includes a control circuit and a plurality of partially defective flash memory devices of the same kind. Each flash memory device included in this nonvolatile memory unit is partially defective and the defective cells are confined in some predefined regions of the memory array of this flash memory device. Further, the defective areas of each flash memory device are complementary to non-defective areas of other flash memory devices. This ensures that each defective area of the aforementioned flash memory devices can be replaced by a non-defective areas located at other flash memory devices, both mapping to the same region of memory array. The control circuit employs switching mechanism to facilitate writing operations to the flash memory devices simultaneously. The control circuit further examines read commands issued by the external circuit and accordingly determines the associated data read cycle to read data from all of the attached flash memory devices simultaneously but selectively connecting the data lines to ensure that data are read out from non-defective storage cells. The nonvolatile memory unit can thereby be treated as a non-defective flash memory device disregarding where the defects occurred in this nonvolatile memory unit.

### BRIEF DESCRIPTION OF THE DRAWING

The present invention is described by way of example and not limited to the figures of the accompanying drawings throughout which like parts are designated by like reference numerals, and in which:

FIG. 1A is a logical view of a memory array having defective storage cells confined in the column of bit 3;

FIG. 1B is a logical view of a memory array having defective storage cells confined in two portions ranging from addresses 0 to i and from addresses from j to N−1, respectively;

FIG. 2A illustrates a logical partition of defects having defective cells confined in the shaded areas;

FIG. 2B is a vertical partition of the same defects as illustrated in FIG. 2A in which the memory arrays schematically illustrated by the two shaded columns are treated as defective;

FIG. 2C is a horizontal partition of the same defects as illustrated in FIG. 2A in which the memory array schematically illustrated by the shaded upper half is treated as defective;

FIG. 3 is a block diagram of the disclosed nonvolatile memory unit 1, which includes a control circuit 3, a plurality of flash memory devices 100 to n00, and internal data buses 10 to n0. The figure further shows an interface to the external circuit including data bus 330, fault pattern setting input 340, control bus 350, and flash memory model input 370;

FIG. 4A is an example of left-right complementarily defective pattern in which the defective area indicated by the shaded column of bit 3 of flash memory device 100 can be replaced by the non-shaded or equivalently non-defective column of bit 3 of flash memory device 200, and vice versa;

FIG. 4B is an example of up-down complementarily defective pattern in which the defective area indicated by the shaded area of flash memory device 100 can be replaced by the non-defective area located at the lower half of memory array of flash memory device 200, and vice versa;

FIGS. 5(a) through 5(n) illustrate an example of fourteen fault patterns of complementary defects, in which seven are horizontal or up-down pattern and the remaining seven are vertical or left-right patterns, and only two flash memory devices are considered;

FIG. 6 is the selection table corresponding to the fault patterns depicted in FIG. 5(a) through FIG. 5(n). Those lines from the data bus 10 of the flash memory device 100 marked by “1” in the selection table are connected to the corresponding lines of data bus 330 for output to the external circuit;

FIG. 7 is a block diagram schematically showing the internal structure of control circuit 3 of the disclosed nonvolatile memory unit with two complementarily defective flash memory devices 100 and 200 in use. The control circuit 3 includes a command/address decoder 31, an input switch circuit 32, a selection circuit 33, a fault pattern circuit 34, and a command table 35;

FIG. 8 is an example showing the typical timing diagram of an asynchronous mode data read operation starting from issuing a read command to completion of data read operation;

FIG. 9 is an example showing the typical timing diagram of a synchronous mode data read operation starting from issuing a read command to completion of data read operation, the various operations are triggered by clock signal CLK provide externally; and

FIG. 10 is an example of the command table disclosed in the present invention showing information related to commands, controls, addresses and data for different kinds of flash memory.

### DETAILED DESCRIPTION OF THE INVENTION

The main functions of a regular semiconductor memory include data reading and writing. To achieve the goals, semiconductor memory often requires provision of control signals or commands externally to ensure the desired reading and writing operations to be carried out. Further, it requires provision of memory addresses externally to point to the locations in memory array where data are to be read from or written into. Of course, there also requires a proper channel to transmit data into and out from the memory. The conventional dynamic random access memory (DRAM) or static random access memory (SRAM) have an independent control bus, address bus and data bus to transmit control signals, addresses and data. Due to the different internal structures, flash memories available nowadays are mainly categorized as NOR type, AND type or NAND type. The NOR type flash memory uses data bus to transmit commands and data and uses address bus to transmit data access addresses. The AND type and NAND type flash memories use data bus to transmit commands, addresses and data. Since AND type flash memory and NAND type flash memory are in general similar in the buses structure, and for simplicity of description of the invention, will be treated as the same type throughout the description that follows below. Though there is difference between the bus structure of NOR flash and NAND flash, the behavior of using data bus to transmit commands for controlling memory access operations is similar and is different from that of random access memory (RAM). In particular, the instruction for memory access of RAM is given externally through independent read/write control lines, not data bus. Furthermore, there are more complicated types of memory access operations in flash memory than in RAM. Therefore, the conventional methods designed to reconfigure a defective RAM by segregating those data lines where erroneous data may come out are not applicable to flash memory. This is because one can not transmit a complete command to the flash memory without using all of the lines of data bus.

Consistent with the characteristic that both commands and data share the same data bus in flash memory, the present invention thus provides a preprogrammable nonvolatile memory unit comprising a control circuit and a plurality of flash memory devices of the same kind. The flash memory devices in use are partially defective in each flash memory device. With the switching scheme disclosed by present invention, the non-defective portions of each partially defective flash memory device can be used for data storage. Further, the provided nonvolatile memory unit can be used as a single flash memory device having specifications exactly the same as that of the flash memory devices in use.

Apart from the situation where electronic characteristics are out of the tolerant ranges, the common functional faults of flash memory include stuck at faults, address decoder faults, and bridging faults. If the portions where the functional faults occur are confined in a certain regions, it is possible to map out the defective areas through reconfiguration of memory arrays and to use those non-defective portions for data storage. Theoretically, the non-defective areas in the memory array can be used to store data if those non-defective areas can be accessed properly.

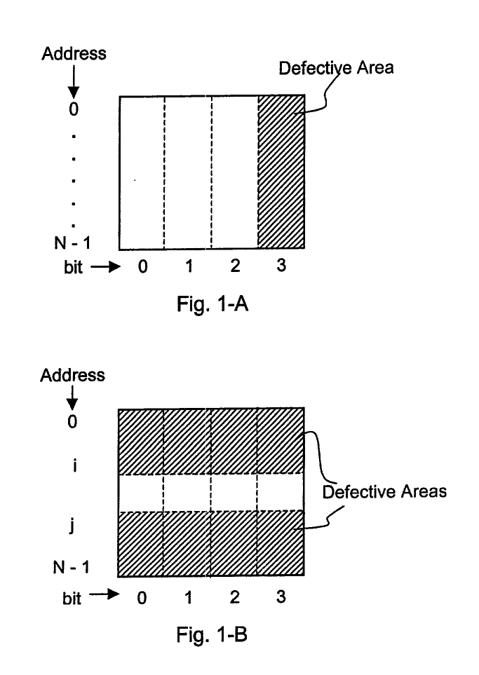

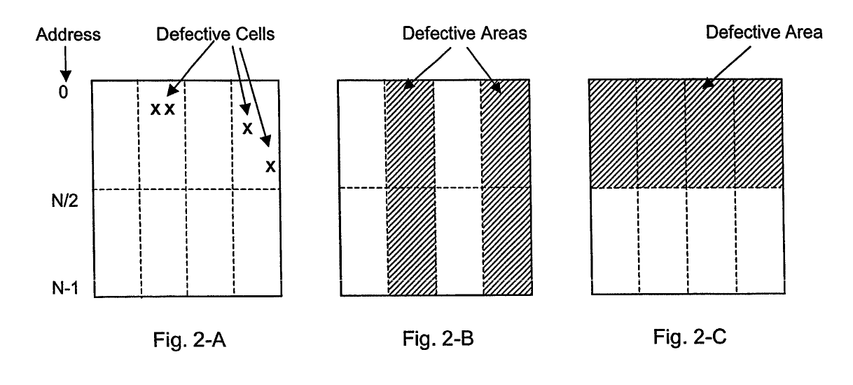

Typically, the defects may be treated as address-oriented or bit-oriented faults depending on how the memory array is partitioned and how the defective areas are allocated to fit in these partitions. FIGS. 1A and 1B illustrate the aforementioned fault types in which FIG. 1A is bit-oriented and FIG. 1B is address-.oriented. In FIG. 1A, the memory is composed of an N×4 memory array, where N=2ⁿ and n is a positive integer. The addressing space in this memory array counting from 0 to N−1. That is, there are N sets of 4-bit data units. In the figure, the defective area is confined in the shaded column of bit 3. There may be one defective memory cell, several defective memory cells, or even worst all of the N memory cells are malfunctioned in the column of bit 3. The reasons for resulting such fault pattern may be stuck at faults or bridging faults. No matter what reasons there are, the columns of bits 0, 1 and 2 of the memory array as depicted in FIG. 1A are non-defective and can be used for data storage if there are proper means to access this non-defective portion. Obviously, one needs to allocate another column of non-defective memory cells to substitute for the defective column of bit 3 so as to achieve the storage capacity of the original N×4 memory array.

FIG. 1B indicates address-oriented fault pattern in which faults occur in two areas ranging from address 0 to address i and from address j to address N−1, respectively. The reasons for such faults may be stuck at faults, bridging faults or address decoder faults. Similarly, no matter what the reason is, FIG. 1B shows that the non-defective memory space in the whole N×4 memory array is located in the area between address (i+1) to address (j−1). Clearly, there requires allocation of a total of (N−j+i+1)×4 memory array to substitute the two defective areas as depicted in FIG. 1B to achieve storage capacity of N×4 bits.

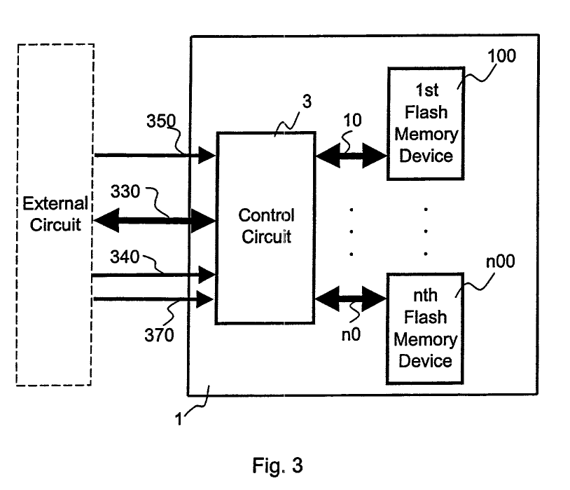

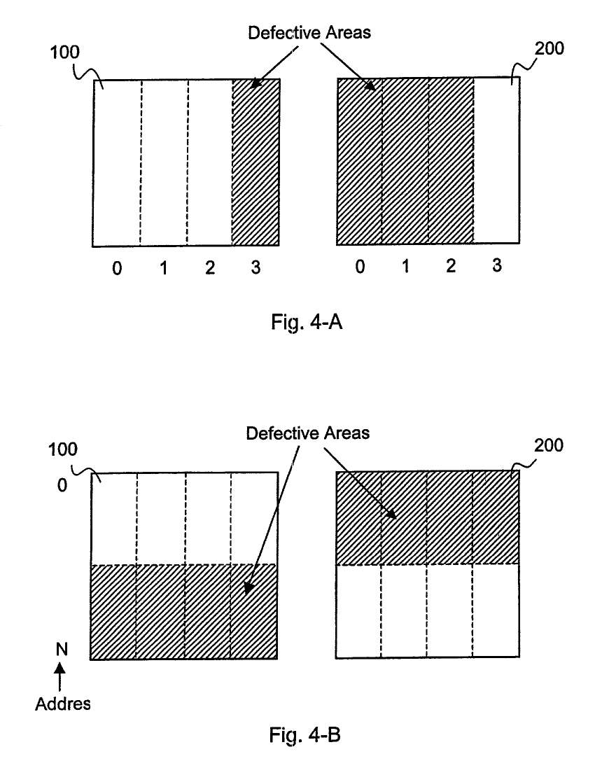

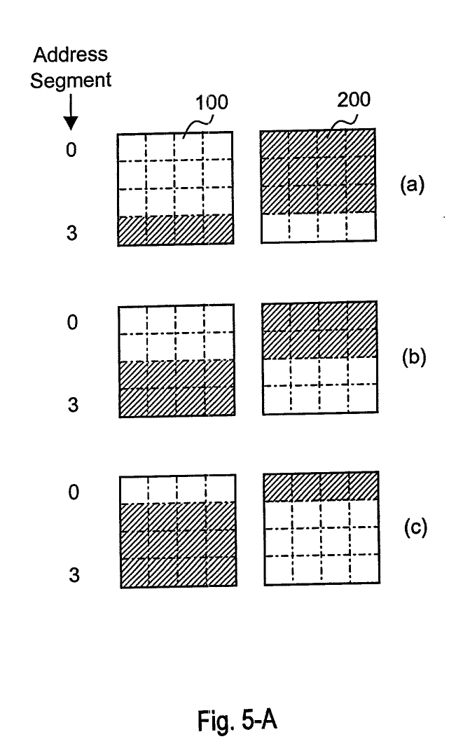

The partition of defective areas may end up with different results depending on different purposes. For example, the faults comprising four defective cells marked by “X” as shown in FIG. 2A can be regarded as faults in the vertical columns as indicated by the shaded areas of FIG. 2B or faults in the horizontal region as indicated by the shaded area of FIG. 2C.

In view of the I/O structure of flash memory that commands and data are transmitted via the same data bus or data lines, the present invention provides a control circuit 3 that maps out defective portions in the flash memory devices to form a nonvolatile memory unit. In accordance with the characteristic that the commands and data are transferred through the same data bus, any segregation of a portion of data lines from the data bus will result in incomplete of command delivery and accordingly the desired operations can not be performed by the flash memory properly. To achieve the objective of providing a nonvolatile memory unit with the partially defective flash memory devices, especially for the bit-oriented fault patterns, a simple switching scheme is provided to facilitate substitution of defective areas by their non-defective counter part.

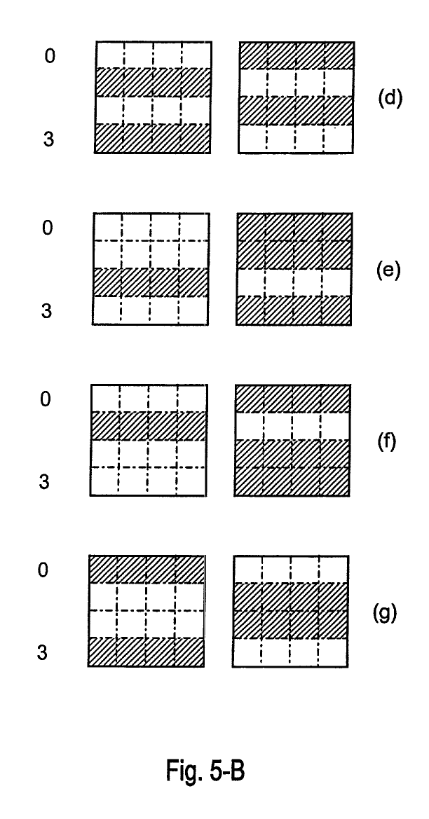

A block diagram of the nonvolatile memory unit provided by the present invention is depicted in FIG. 3. In FIG. 3, the nonvolatile memory unit 1 is composed of a plurality of flash memory devices 100 to n00 and a control circuit 3. The flash memory devices 100 to n00 are of the same kind but having partially defective in each flash memory device. The defective portions are aligned in a certain layout called complementary fault pattern that will be defined and described later in this presentation. The control circuit 3 explicitly implements the control circuit to facilitate switching operation as stated above to ensure data output from non-defective storage cells. In practice, the partially defective flash memory devices to be operated in conjunction with the control circuit 3 are first tested and the corresponding fault pattern is determined before assembly of the flash memory devices onto the circuit board. The fault pattern of the defective areas in the flash memory devices 100 to n00 is then recorded in the control circuit 3 via the selection lines 340.

The data bus 330 is the input-output data path of the nonvolatile memory unit 1 to the outside world. It can be used to transfer data in and out and receive commands externally for the flash memory devices. If the flash memory devices 100 to n00 are NAND type flash memory, then the data bus 330 is also used to receive addresses. Unlike DRAM in which the memory access scheme is almost standardized for different models and vendors, the operations of flash memory are often proprietary and the internal structures are also vendor or even model dependent. Different memory access operations and commands may therefore be resulted for different kinds of flash memory. In order to establish the operability of the control circuit 3 for different kinds of flash memory, the product code that specifies the kind of the flash memory devices to be in use in conjunction with the control circuit 3 is entered via the input lines 370. The control circuit 3 is then based on the particular product code to examine the input commands and to perform switching operation among the data lines during the memory read cycle.

The external circuit generates commands, addresses, control signals and data to the nonvolatile memory unit 1 to perform desired operations normally carried out by a flash memory device. The commands, addresses, control signals are indeed sent to the n flash memory devices 100 to n00 simultaneously via control circuit 3 as illustrated in FIG. 3. When a data read command is performed, the control circuit 3 first determines the starting point of data read cycle. During data read cycle, the control circuit 3 connects those particularly selected data lines from flash memory devices 100 through n00 to data bus 330 so that data from non-defective portions of flash memory devices 100 to n00 can be read out by the external circuit. Selection of the data lines from each flash memory device is based on the complementary fault pattern associated with flash memory devices 100 to n00 and is predetermined and preprogrammed into the control circuit 3 via selection lines 340. The control circuit 3 then based on the complementary fault pattern to determine via which data lines of flash memory devices 100 to n00 data from non-defective storage cells are read out. The control circuit 3 then further connects these data lines to data bus 330 and through which the external circuit can read correct data from the nonvolatile memory unit 1.

To more clearly explain the concept of the invention, two complementarily defective flash memory devices are used for illustration in the remaining of this presentation. The nonvolatile memory unit 1 as shown in FIG. 3 is therefore composed of only two flash memory devices 100 and 200 throughout the description that follows below. The concept disclosed below, however, can be extended to a more general case where the nonvolatile memory unit 1 is composed of n flash memory devices as depicted in FIG. 3.

First, the complementary properties of the defective areas are defined as follows. As stated above, the memory array can be partitioned by address-oriented basis or bit-oriented basis. Specifically, the memory array is equally partitioned into K=2^{k} segments in addressing space, and is equally partitioned into L=2^{l} strips where each strip indeed comprises 2^{d} bits with 1≦2^{d}≦D, D is the number of bits per data unit stored in the memory array. The memory array of a flash memory can therefore be represented by an array M comprising K segments or H strips as follows:

M=[SE₁, SE₂, . . . , SEₖ]^{T}=[ST₁, ST₂, . . . , ST_{H}]

Here, SE₁ stands for the ith segment of the memory array and ST_{J} stands for the jth strip of the memory array. Accordingly, the memory arrays of flash memory device A and flash memory device B are represented as M_{A}=[SE^{A}₁, SE^{A}₂, . . . , SE^{A}_{K}]^{T}=[ST^{A}₁, ST^{A}₂, . . . ST^{A}_{H}] and M_{B}=[SE^{B}₁, SE^{B}₂ . . . , SE^{B}_{K}]^{T}=[ST^{B}₁, STB₂, . . . , ST^{B}_{H}], respectively. Further, if a segment SEi in memory array is non-defective, then the segment is in state “1”; otherwise, there are some defective cells in this segment, and the segment is in state “0”. Similarly, a strip STj is in state “1” if all of the cells in this strip are non-defective, and in state “0” if part or all of the cells in this strip are defective. Flash memory devices A and B are complementarily defective if one of the following state conditions is satisfied:

se^{A}ᵢ·(se^{B}₁)′+(se^{A}ᵢ)′·se^{B}₁=1 for 1≦i≦K; or (1)

st^{A}ⱼ·(st^{B}ⱼ)′+(st^{A}ⱼ)′·st^{B}_{J}=1 for 1≦j≦L (2)

Here se^{A}₁ and st^{A}ⱼ are states of segment i and strip j of flash memory device A, and se^{B}ᵢ and st^{B}_{J} are states of segment i and strip j of flash memory device B, respectively. Further, (X)′ is the complement of X. That is, if X=1, then (X)′=0. A generalized definition of complementarily defective flash memory devices Al to An is further given if one of the following conditions is true:

(se^{A1}ᵢ)′·(se^{A2}₁)′· . . . ·se^{Ah}ᵢ . . . ·(se^{An}ᵢ)′=1 for 1≦i≦K and Ah∈{A1, A2, . . . , An}; or (1)

(st^{A1}ⱼ)′·(st^{A2}ⱼ)′· . . . ·st^{Ah}ⱼ . . . ·(st^{An}ⱼ)′=1 for 1≦j≦L and Ah∈{A1, A2, . . . , An} (2)

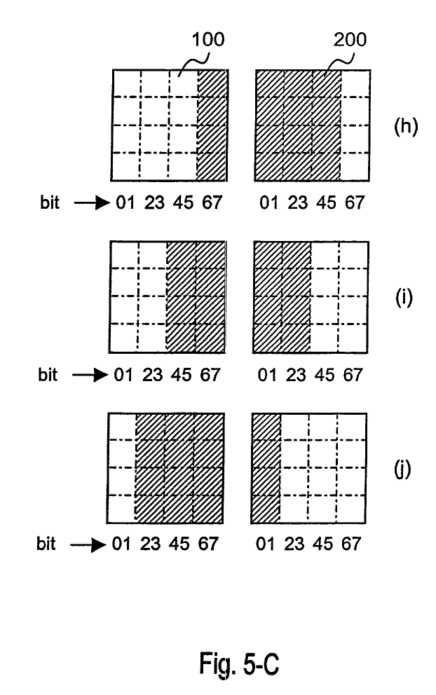

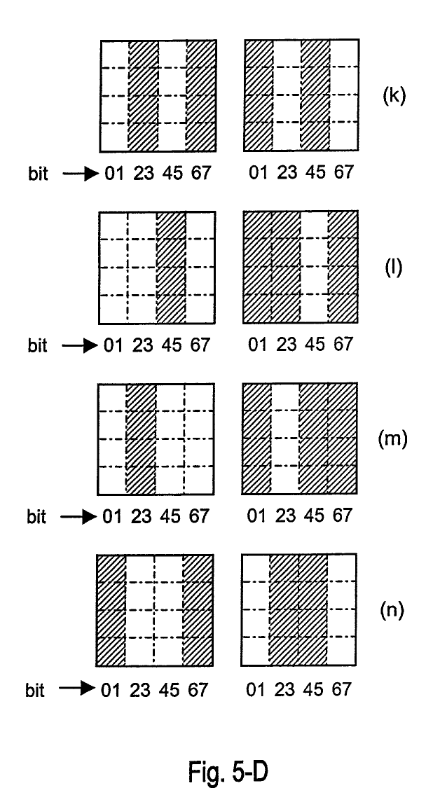

In the two defective flash memory devices 100 and 200 as shown in FIG. 4, the memory arrays of both flash memory devices are partitioned into 4 strips as shown in FIGS. 4A and 2 segments as shown in FIG. 4B. In FIG. 4A, the flash memory device 100 has faults at bit 3 and the flash memory device 200 has faults in bits 0, 1, and 2. According to the definition given above, the defective and non-defective areas of the two flash memory devices 100 and 200 are complementary to each other. Therefore, the faults are called complementary faults. When the faults in the two flash memory devices 100 and 200 are complementary, it is fairly easy to perform substitution of data storage areas. Specifically, the defective strip in the flash memory device 100, namely, bit 3, can be replaced by the non-defective strip (bit 3) in the other flash memory device 200. As a result, data can be written to the two flash memory devices 100 and 200 simultaneously without a prior knowledge of where the defective cells are exactly located. On the other hand, data is read out from both of the flash memory devices simultaneously according to the address provided externally. However, a proper switching mechanism is required to obtain the data stored in bits 0, 1, and 2 of the flash memory device 100 and bit 3 of the flash memory device 200. This will ensure all data reading out from non-defective strips of flash memory devices 100 and 200 and thereby data output from the nonvolatile memory unit 1 are correct.

For the simplicity of illustration, we call the fault pattern depicted in FIG. 4A a left-right or vertical complementary type fault pattern and fault pattern depicted in FIG. 4B a up-down or horizontal complementary type fault pattern. For the up-down complementary type fault pattern as shown in FIG. 4B, the defective segments in the flash memory device100 can also be replaced by the non-defective segments in the flash memory device 200. Namely, the defective lower half of flash memory device 100 should be replaced by the non-defective lower half of the flash memory device 200, and vice versa, to achieve full storage capacity. In this case, data is written into the two flash memory devices 100 and 200 simultaneously, and data is read out from the flash memory devices 100 and 200 at the same time. However, selection of data being read out from the two flash memory devices 100 and 200 is required to obtain correct data. If the address of the data being read out pointing to the upper-half of memory array, the switching scheme should connect the output data path to the flash memory device 100 for data output. Otherwise, the switching scheme switches the output data path to flash memory device 200 to read out the data.

The present invention is therefore particularly useful for the use of complementarily defective flash memory devices that normally can not be used due to incorrectness of data storage. Indeed, by entering commands and data simultaneously to the complementarily defective flash memory devices, and properly selecting data lines from the data outputs of each flash memory device during data read cycle, the present invention ensures correct data storage in and data retrieval from those complementarily defective flash memory devices.

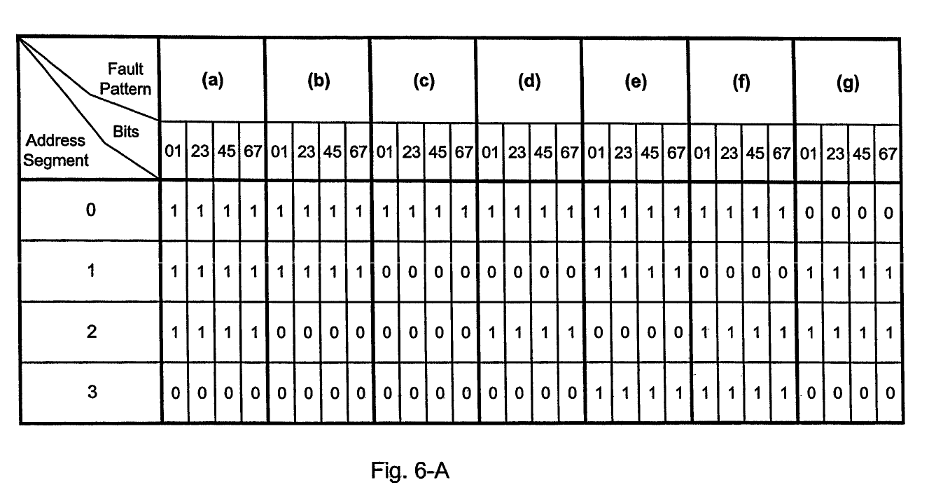

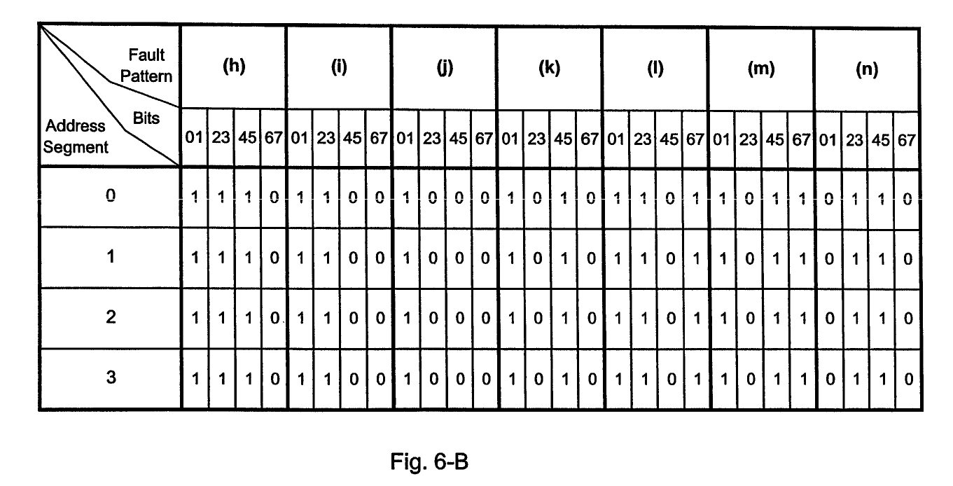

In consideration of the cost for practical applications, the partition of memory array can be constrained to a certain degree and therefore limiting the fault patterns to a reasonable number. For example, a memory array with 8-bit data output can logically be divided into 4 strips and 4 segments. In this case, one may obtain a total of fourteen complementary fault patterns with complementarily defective areas as depicted in FIG. 5(a) to FIG. 5(n). Clearly, the fault patterns of FIG. 5(a) to FIG. 5(g) are horizontal or up-down complementary fault patterns while the fault patterns of FIG. 5(h) to FIG. 5(n) are vertical or left-right complementary fault patterns. Therefore, when using flash memory devices with a particular complementary fault pattern as prescribed in FIG. 5, the code corresponding to that fault pattern has to be entered into the control circuit 3 via the selection lines 340. The control circuit 3 can then perform data line switching, according to the selection table as shown in FIG. 6, to obtain correct data from flash memory devices 100 and 200 when read operation is performed.

The selection table as shown in FIG. 6 indicates the connection configuration of data lines 10 of the flash memory device 100 to data bus 330 via the control circuit 3 when fault patterns of FIG. 5 are considered, where “1” refers to connection and “0” to disconnection. Accordingly, if the defective cells in both flash memory devices 100 and 200 are confined to the strips as depicted in the fault pattern of FIG. 5(h). Then according to the selection table as shown in FIG. 6, the data lines labeled 0 to 5 of the flash memory device 100 are connected to the lines 0 to 5 of data bus 330 disregarding where data is to be read out. Meanwhile, the control circuit 3 connects the data lines with bits labeled 6 and 7 of the flash memory device 200 to lines 6 and 7 of data bus 330. This exactly integrates the non-defective strips in the flash memory device 100 and the flash memory device 200 together as shown in FIG. 5(h) to facilitate correct data storage and data retrieval.

Similarly, for the complementarily defective areas as shown in FIG. 5(b), the reconfiguration of data lines by the control circuit 3 is independent of the data bits of flash memory devices 100 and 200 according to the selection table of FIG. 6. Instead, it depends upon the address where data is read out. If the data being read out is stored in the upper half of memory array, then the data bus 10 of the flash memory device 100 is connected to the data bus 330. If the data being read out is in the lower half of memory array, then the data bus 20 of the flash memory device 200 is connected to the data bus 330. In practice, the regions, either strips or segments, that are treated as the basic elements for the aforementioned complementary fault patterns may be further partitioned into smaller pieces for more effective use of the defective flash memory. For instance, one may partition the addressing space into eight of sixteen segments. In this case, there will be an increase of eligible fault patterns with the cost of increasing complexity of the selection table. The selection table can be modified by adapting the concept as stated and illustrated above.

As shown in FIG. 3, the control circuit 3 is mainly used as an interface between the complementarily defective flash memory devices and the external circuit. Its main functions include transmitting commands and data from. the external circuit to the flash memory device 100 and the flash memory device 200. The control circuit 3 also determines the data read cycle by examining each command transmitted externally to the flash memory devices 100 and 200. During data read cycle, the control circuit 3 selects those data lines that output data from non-defective areas and connects these data lines to data bus 330, from which the data is read out and transmitted to the external circuit.

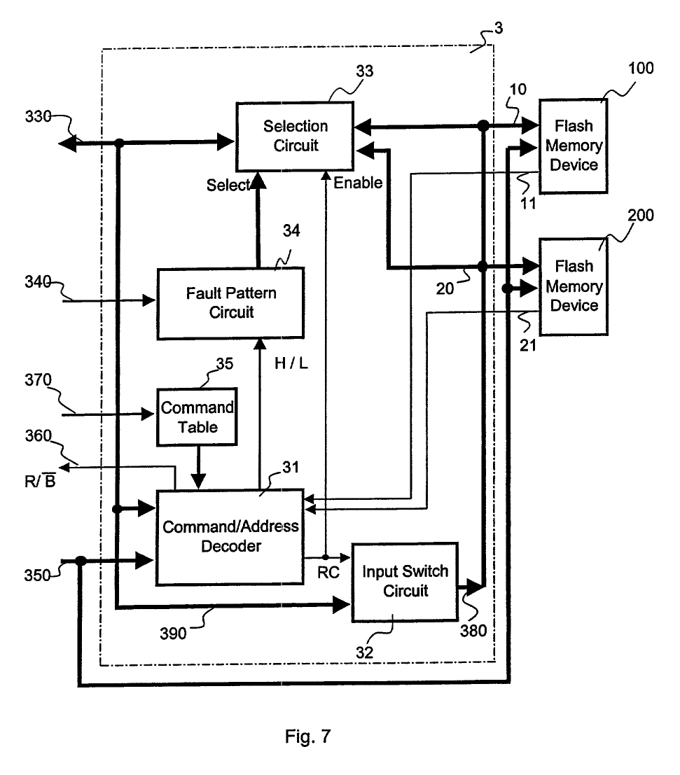

With reference to FIG. 7, a preferred embodiment of the control circuit 3 in accordance with the present invention has a command/address decoder 31, an input switch circuit 32, a selection circuit 33, a fault pattern circuit 34 and a command table 35.

The command/address decoder 31 examines each input command from data bus 330 and control bus 350. If a read command is detected, the command/address decoder 31 determines the beginning and ending time of a data read cycle according to address input from the data bus 330 and the control signals input from the control bus 350. The command/address decoder 31 generates a read cycle (RC) signal during data read cycle to change the data flow direction between flash memory devices 100, 200, and the external circuit. If the flash memory devices in use are of the NOR type, the address is not entered through the data bus but through a separate address bus. For simplicity of illustration, in this case, the address bus and control bus are depicted by a control/address bus 350.

The command table 35 receives the product code through the input lines 370 to identify the particular model of the flash memory devices 100, 200 connected to the control circuit 3. The relevant information related to the commands of flash memory devices connected to the control circuit 3 is then sent to the command/address decoder 31 to facilitate desired decoding functions for that particular model of flash memory. The control circuit 3 can therefore determine the beginning and ending time of data read cycle for different model of flash memory provided that the information related to the commands of that particular model is preprogrammed in the command table 35. It is noted that the flash memory device 100 and the flash memory device 200 have to be of the same kind, namely, of the same brand and the same model. When a read cycle (RC=1) is detected by the command/address decoder 31, the selection circuit 33 is enabled. The output of the fault pattern circuit 34 is used by the selection circuit 33 to select particular lines of input data buses 10 and 20 and connecting to the corresponding lines of its output data bus 330. In the mean time, the input switch circuit 32 segregates the data path 380 and data path 390 when RC=1 and thus blocking data flow from external circuit to the flash memory devices 100 and 200. This will ensure unidirection of data flow from flash memory devices 100 and 200 to the external circuit via selection circuit 33.

On the other hand, when RC=0, the data path in the input switch circuit 32 is closed making signals flowing in an opposite direction from external circuit to the flash memory devices 100 and 200 via data paths 380 and 390. Whilst selection circuit 33 is disabled during RC=0 resulting blocking of data transfer from the flash memory devices 100 and 200 to the external circuit.

When performing data read/write, especially under the asynchronous control mode, the R/\overline{B} (Ready/\overline{Busy}) output of the flash memory is an important reference for the status of operation. R/\overline{B} can be used as a time stamp for starting or ending of a certain operations. Therefore, the R/\overline{B} output 11 of the flash memory device 100 and the R/\overline{B} output 21 of the flash memory device 200 are fed into the command/address decoder 31. After ANDing those two signals by the command/address decoder 31, the R/\overline{B} signal is output via an R/\overline{B} line 360 to the external circuit.

The command/address decoder 31 also decodes the address to determine the location from which data is read out and outputs an H/L signal for the fault pattern circuit 34 to make selection control, if the complementary fault pattern is a up-down fault pattern. The fault pattern circuit 34 provides data selection input for the selection circuit 33 to make 2-to-1 selection (2-to-1 multiplexing) on each data line coming from data buses 10 and 20, according to the fault pattern and the address where data is to be read out. As stated above, the defective areas of the two flash memory devices 100 and 200 must be complementary, and are determined and classified to a fault pattern by an off-line testing process before mounting the two flash memory devices to the circuit board. Specifically, the fault pattern of the complementarily defective flash memory devices 100 and 200 is tested and determined based on a set of eligible fault patterns that fulfill the aforementioned complementary behavior and are predetermined at the time when control circuit 3 is designed. A code associated with the particular fault pattern is preprogrammed to the fault pattern circuit 34 through lines 340. The fault pattern circuit 34 is then based on the selection table to instruct the selection circuit 33 to perform line selection among the data lines of data buses 10 and 20 during data read cycle (RC=1), and connecting those selected lines to data bus 330. This ensures transfer of data from non-defective storage cells to the external circuit via data bus 330. The objective of mapping out the defective areas and using the non-defective areas for data storage is therefore achieved. Notice that the selection table as depicted in FIG. 6 provides a simple mapping of the data lines of flash memory device 100 that are to be connected to data bus 330 for a particular read command. Since the strips and segments are predetermined, and further, the eligible complementary fault patterns are also predetermined, as a result implementation of the selection table can be purely logical. The cost of mapping out non-defective areas (strips or segments) is therefore relatively cheap compared to that of the prior arts in which additional nonvolatile semiconductor memory is required for address conversion.

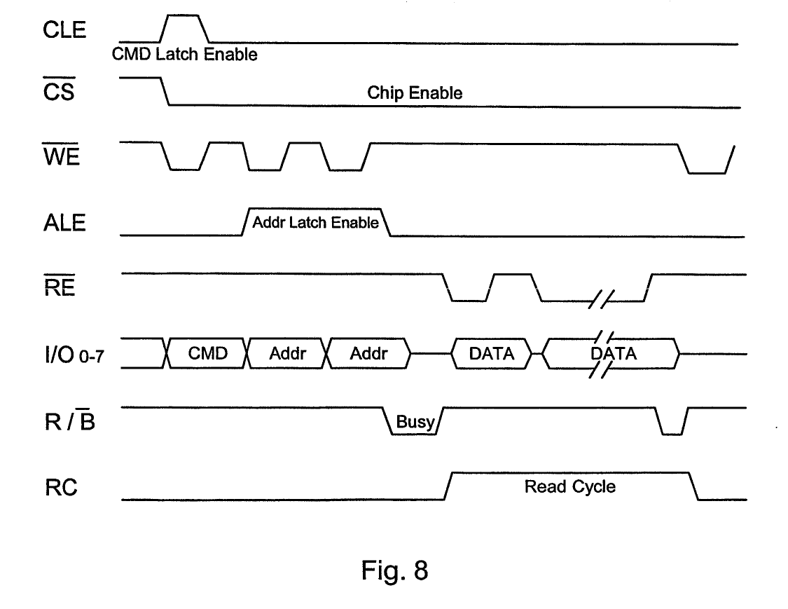

FIG. 8 is an example of timing diagram illustrating a data read operation of an asynchronous mode NAND type flash memory. Operations of the control circuit 3 when operating in asynchronous mode will be described below in accordance with the example depicted in FIG. 8. In FIG. 8, commands and addresses are sent from the external circuit to the command/address decoder 31 via data bus 330 (I/O_{0˜7}), and the control signals CLE, \overline{CS}, \overline{WE}, ALE, and \overline{RE} are sent from the external circuit to the command/address decoder 31 via control bus 350.

When the voltage of Chip Select \overline{CS} drops from high to low, the command/address decoder 31 is enabled and starts latching command from the data bus 330 when the voltage of CLE (command latch enable) goes from low to high. If the command is a data read command, it will be followed by an address indicating the starting address of data stream to be read out. The command/address decoder 31 starts latching the address from the data bus 330 when the voltage of ALE (address latch enable) goes from low to high, and generates a selection signal H/L indicating the segment where data is to be read out for the fault pattern circuit 34. If the flash memory is of the NOR type, address is input through the control/address bus 350 and accordingly the command/address decoder 31 obtains address from the bus 350, rather than data bus 330. Depending on the type of read command, the address may be a short address or a long address. In this case, the address shall be sent in several address cycles. The command/address decoder 31 will fetch the address from the data bus 330 in consecutive address cycles and then derive the complete address for that particular read command. \overline{WE} pulls low when the commands or addresses are available on the data bus 330 (or control/address bus 350 for a NOR type flash memory).

After the flash memory device receives a read command to read data, it reads data from the memory array into an internal register first. At this time, the flash memory device enters the busy state (R/\overline{B}=0). The data is not available on the data bus yet. When the data is available on the data bus of the flash memory device and is ready to be read out, the flash memory device pulls voltage of R/\overline{B} from low to high. Since there may have slight time offset for the R/\overline{B} sending out from the flash memory devices 100 and 200, the control circuit 3 performs AND operation on the two R/\overline{B} signals 11 and 21 and sends the result to the external circuit via R/\overline{B} line 360. This is to ensure that data is really ready on the data buses of both flash memory devices 100 and 200. After receiving state transition of R/\overline{B} 10 from low to high, the external circuit will send out a Read Enable signal \overline{RE} to read data from the nonvolatile memory unit 1. At this time, the control circuit 3 should change direction of data flow from the flash memory devices 100 and 200 to the external circuit so as to accomplish the desired read operation. Specifically, the command/address decoder 31 sets RC to “1” indicating the start of a read cycle. This results in an open of the input switch circuit 32 to segregate the data paths 380 and 390 so that no signal can be transferred into flash memory devices 100 and 200 through the data paths of 330, 380 and 390. Meanwhile, the setting of RC=1 also activates the selection circuit 33 so that reconfiguration of data buses 10 and 20 can be performed and the data flow direction of the data bus 330 is changed from the control circuit 3 to the external circuit. The command/address decoder 31 will maintain the state of RC until a state transition of R/\overline{WE} from high to low is detected indicating a start of another command input or the Chip Select \overline{CS} going from low to high indicating the present flash memory unit 1 is no more selected. Whatever case it is, this implies the end of the present data read cycle. When this happens, a reset of RC to “0” results in a change of direction of data flow from the external circuit to the control circuit 3 and to the flash memory devices 100 and 200 by disabling the selection circuit 33 and closing the input switch circuit 32.

The aforementioned example is provided to illustrate the operations employed by the control circuit 3 to segregate the defective portions of flash memory devices connected to control circuit 3 when data is read out from the nonvolatile memory unit 1. However, since flash memories of different kinds may have different command set and control sequences, therefore a command table 35 is constructed to store essential information regarding to read commands and their associated operations for various kinds of flash memory. The objective is to provide decision rules for identifying read commands and determining the read cycle for the particular kind of flash memory devices that are connected to the control circuit 3 to form a nonvolatile memory unit 1. The control circuit 3 is therefore operable to work with a variety of flash memories for fault isolation and for data storage on complementarily defective flash memory devices.

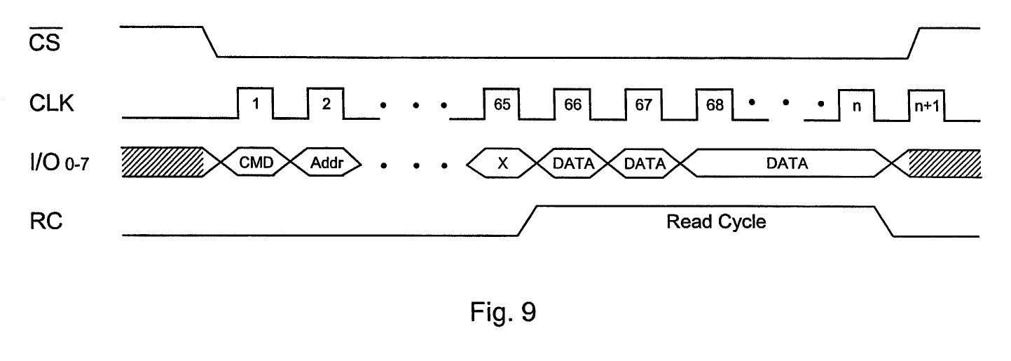

FIG. 9 is another example of timing diagram illustrating a data read operation of a synchronous mode NAND type flash memory. Operations of the control circuit 3 when operating in synchronous mode will be described below in accordance with the example depicted in FIG. 9. In FIG. 9, the command/address decoder 31 obtains commands and addresses from data bus 330 according to the chip select \overline{CS} and clock input CLK on the control bus 350. For the synchronous mode flash memory, the operations are triggered by clock input CLK, when the flash memory device is enabled by chip select \overline{CS}. In particular, each operation following the previous operation is triggered by a specific clock pulse and has a fixed duration in between these two operations. Taking the example of FIG. 9 into consideration, the read command is entered at the first clock pulse, and the address is entered starting from the second clock pulse. The data read cycle of this read command starts from the 66th clock pulse and ends at the nth clock cycle. The control sequence of this read command should be coded properly in the command table 35, and will be used by the command/address decoder 31 to obtain commands and addresses at the particular time instants counting by the clock pulses. The command/address decoder 31 will then based on the decoded read command and the corresponding control sequence specified in the command table 35 to determine the starting time and duration of the read cycle. The switching operations to perform direction change of data flow and the selection of data paths are similar to that of the asynchronous mode stated above.

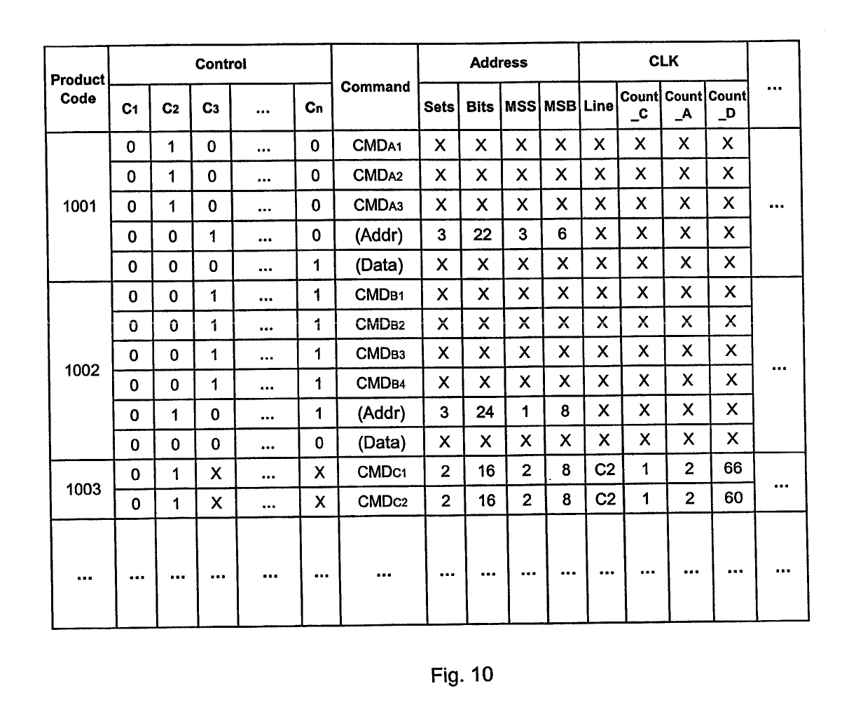

FIG. 10 is an example of command table where information related to read commands of three product codes 1001, 1002 and 1003 is illustrated. The example only shows those items to be used to describe how the information can be applied by the command/address decoder 31 for identifying a read command, retrieving the provided address, and for determining the data read cycle. It may contain more items characterizing the read commands and their associated read operations when more varieties of flash memories are taken into consideration. In the table of FIG. 10, the columns labeled “Control” are composed of n control lines, C1, C2, . . . Cn, and is the elements of control bus 350 or a part of control/address bus 350 when control circuit 3 is used incorporated with NOR type flash memory devices. The control lines C1, C2, . . . Cn can be assigned arbitrarily corresponding to the line assignments, such as \overline{CS}, \overline{WE}, \overline{RE}, CLE, ALE, etc., for each particular kind of flash memory. However, in order to simplify the explanation of the use of this table, the control line C1 is particularly designated as chip select \overline{CS}.

In the example as shown in FIG. 10, the flash memory with model number 1001 has three data read commands, namely, CMDA1, CMDA2, and CMDA3. The mark “X” indicated in the column “Line” under “CLK” means that there is no clock input required and therefore the operations are carried out in asynchronous mode.

When the control bus 350 has the input C1C2C3 . . . Cn=0 1 0 . . . 0, the chip select \overline{CS} (C1) is at “0” logical level implying the nonvolatile memory unit 1 is selected. The control circuit 3 is thereby enabled to ensure proper memory access of nonvolatile memory unit 1 by external circuit. the command/address decoder 31 obtains commands from the external data bus 330. When the control inputs C1C2C3 . . . Cn=0 0 1 . . . 0 appear on the control bus 350, the command/address decoder 31 obtains addresses from the external data bus 330 (or control/address bus 350 if model 1001 is a NOR type flash memory).

In the command table as shown in FIG. 10, the “Address” column provides information related to addresses. “Sets” refers to the number of sets or address cycles to input a complete address. “Bits” refers to the number of bits in a complete address. “MSS”, or equivalently “the most significant set”, refers to the input set in which the most significant bits are entered. “MSB”, or equivalently “the most significant bit”, refers to the bit numbering where the most significant bit appears in the most significant set of address. Therefore, in the present example of FIG. 10, the address of the flash memory with the product code 1001 occupies 22 bits and each complete address is transmitted in three sets. The most significant bits are transmitted in the third set and the most significant bit is the sixth bit of the third set. When the command/address decoder 31 determines the command as a data read command, it further obtains the address according to the aforementioned transmitting sequence of address. The command/address decoder 31 can determine which segment in memory array the provided address is located and accordingly generates an H/L signal for the fault pattern circuit 34. The H/L signal is further used incorporated with the complementarily fault pattern preprogrammed in the selection table of the fault pattern circuit 34 to generate a select signal for the selection circuit 33. On the other hand, when the command/address decoder 31 determines a data read command and when the control input on the control bus 350 labeled by C1C2C3 . . . Cn=0 0 0 . . . 1, the command/address decoder 31 immediately generates RC=1 to turn off the input switch circuit 32. Alternatively, RC is used to enable the selection circuit 33 to construct a data path from flash memory devices 100 and 200 to the external circuit via data bus 330 as stated above.

Taking the flash memory with product code 1003 in FIG. 10 as another example, the symbol “C2” specified in the column “Line” under “CLK” corresponding to the rows of product code 1003 indicates that the control line of the control bus 350 labeled C2 is a clock input. The flash memory coded as 1003 is therefore operated in synchronous mode. As stated above, the clock input to flash memory device is meaningful only when this device is enabled by chip select \overline{CS} (C1). Therefore, the clock starts counting only when the signal level of \overline{CS} is switched from high (“1”) to low (“0”). That is, when the input of the control bus 350 labeled by C1C2C3 . . . Cn=0 1 X . . . X, it starts counting the clock. Here “X” means “don't care” and the associated lines of control bus 350 are useless. Further, since C2 is clock input, the symbol “1” specified at the column of C2 of the table indicates that all the operations are triggered by rising edge of the clock pulses. If “0” is entered instead, it implies that the operations are triggered by falling edge of the clock pulses. Taking the command CMD_{C1}, as an example, during the first clock pulse (Count_C=1), the command is entered via data bus 330. Starting from the second clock pulse (Count_A=2), the address is input via data bus 330 (or control/address bus 350 if the flash memory devices 100 and 200 are NOR type flash). The table also provides the information of how to retrieve and translate the given address of CMD_{C1}. According to the table in which the value corresponding the column of “Sets” indicates that the address is entered by two sets in two consecutive clock cycles, and the most significant bit of the address is entered in the second set. Finally, the data in the flash memory is read out starting from the 66^{th} clock pulse (Count_D=66).

In summary, the invention provides an economic way to use flash memory devices that are partially defective. The defective portions may be address-oriented or bit-oriented, as long as the fault patterns of the flash memory devices in use are complementary.

Although the present invention has been described in connection with the preferred embodiments thereof with reference to the accompanying drawings, it is to be noted that various modifications and changes may be made thereto without departing from the broader spirit and scope of the invention as set forth in the appended claims. For example, EEPROM or other nonvolatile semiconductor memory can achieve the same objectives following the spirit of the invention. The specification and drawings are, accordingly, to be regarded in an illustrative rather than a restrictive sense.

What is claimed is:

1. A nonvolatile memory unit, comprising
(A) a plurality of flash memory devices of the same kind in which each flash memory device is partially defective;
(B) a control circuit for writing data into said flash memory devices simultaneously when writing operations are performed and reading data from said flash memory devices simultaneously but selectively choosing data from non-defective storage cells of said flash memory devices for output when reading operations are performed, said non-defective storage cells constituting data of a particular address for read operation may be all located at a single flash memory device of said flash memory devices, or spread across said flash memory devices.

2. The nonvolatile memory unit of claim 1, wherein said a plurality of flash memory devices comprising partially defective flash memory devices, said flash memory devices are complementarily defective.

3. The complementarily defective flash memory devices of claim 2, wherein locations in the memory array of a particular flash memory device of said flash memory devices, where functional faults occur, are confined in a certain predetermined regions and are complementary to the non-defective regions in other said flash memory devices, said regions are results of equal partitioning of memory array of said flash memory device into address-oriented segments or bit-oriented strips, said a plurality of flash memory devices, denoted by A1, A2, . . . , An, are complementarily defective if one of the following conditions is satisfied:
(se^{A1}₁)′·(se^{A2}ᵢ)· . . . ·se^{Ah}₁ . . . ·(se^{An}ᵢ)=1 for 1≦i≦K and Ah∈{A1, A2, . . . , An}; or (1)
(st^{A1}ⱼ)··(st^{A2}ⱼ)·· . . . ·st^{Ah}ⱼ . . . ·(st^{An}ⱼ)=1 for 1≦j≦L and Ah∈{A1, A2, . . . , An} (2)
where se^{Ah}₁ and st^{Ah}ⱼ represent states of segment i and strip j of flash memory device Ah, respectively, and (·)′ represents complement of a logic variable (·), said state of a segment se^{Ah}ᵢ of said flash memory device Ah is in state “1” if said segment is non-defective, and is in state “0” if there are defective cells in said segment, said state of strip st^{Ah}ⱼ of said flash memory device Ah is in state “1” if said strip is non-defective, and is in state “0” if there are defective cells in said strip.

4. The nonvolatile memory unit of claim 1, wherein said control circuit determines data read commands sending from external circuit and whereby determines data read cycle, said control circuit further selects data lines from said a plurality of flash memory devices during said data read cycle, said data lines output data reading out from non-defective storage cells of said a plurality of flash memory devices, said control circuit whereby outputs data selectively from said data lines to said external circuit.

5. The nonvolatile memory unit of claim 1, wherein said nonvolatile memory unit is used as a single flash memory device of the same kind of said a plurality of flash memory devices which constitute said nonvolatile memory unit, disregarding where defects are occurred.

6. The nonvolatile memory unit of claim 1, wherein said control circuit further comprising:
(A) a command/address decoder for receiving commands input externally and identifying read commands and further determining data read cycle, also for determining said segment where the provided address for read operation is located;
(B) an input switch circuit which disconnects data path from said external circuit to said a plurality of flash memory devices during data read cycle, and directs signals or data flow from said external circuit to said a plurality of flash memory devices in other time;
(C) a fault pattern circuit which records the complementarily fault pattern of said a plurality of flash memory devices, and provides a selection table for eligible complementary fault patterns, and further provides mapping information corresponding to said complementary fault pattern of said a plurality of flash memory devices by said selection table for selecting data lines through which data are read out from non-defective storage cells of said flash memory devices of said nonvolatile memory unit;
(D) a selection circuit which provides switching means for constructing a data path for output from said a plurality of flash memory devices to said external circuit, each data line of said data path is selected based on said mapping information provided by said fault pattern circuit and is selected from one of the data lines having the same line assignment of every data bus of said flash memory devices of said nonvolatile memory unit;
(E) a command table for storing codes of a variety of read commands of different kinds of flash memories and their associated information regarding data read operations. Said command table establishes ability of said control circuit to manage different kinds of flash memories by the same circuitry.

7. The fault pattern circuit of claim 6, wherein said complementary fault pattern is entered and stored at the time when said nonvolatile memory unit is assembled, said complementary fault pattern is predetermined by off-line testing by which flash memory devices having defects matching one of said eligible complementary fault patterns are selected for assembly to constitute said nonvolatile memory unit.

8. The eligible complementary fault patterns of claim 7, wherein said eligible complementary fault patterns of said flash memory devices of said nonvolatile memory unit are predetermined at the design stage of said control circuit, each said eligible complementary fault pattern has property that said flash memory devices, denoted by A1, A2, . . . , An, are complementarily defective if one of the following conditions is satisfied:
(se^{A1}₁)′·(se^{A2}ᵢ)· . . . ·se^{Ah}₁ . . . ·(se^{An}ᵢ)=1 for 1≦i≦K and Ah∈{A1, A2, . . . , An}; or (1)
(st^{A1}ⱼ)··(st^{A2}ⱼ)·· . . . ·st^{Ah}ⱼ . . . ·(st^{An}ⱼ)=1 for 1≦j≦L and Ah∈{A1, A2, . . . , An} (2)
where se^{Ah}ᵢ and st^{Ah}ⱼ represent states of segment i and strip j of flash memory device Ah, respectively, and (·)′ represents complement of a logic variable (·), said state of a segment se^{Ah}ᵢ of said flash memory device Ah is in state “1” if said segment is non-defective, and is in state “0” if there are defective cells in said segment, said state of strip st^{Ah}ⱼ of said flash memory device Ah is in state “1” if said strip is non-defective, and is in state “0” if there are defective cells in said strip.
